(19) United States
(12) Patent Application Publication
(10) Pub. No.: US 2018/0330163 A1
(43) Pub. Date: Nov. 15, 2018

(54) IMAGE PROCESSING APPARATUS AND IMAGE PROCESSING METHOD

(71) Applicant: CANON KABUSHIKI KAISHA, Tokyo (JP)

(72) Inventor: Eiichi Matsuzaki, Chofu-shi (JP)

(21) Appl. No.: 15/974,134

(22) Filed: May 8, 2018

(30) Foreign Application Priority Data
May 11, 2017 (JP) 2017-094877

(51) Int. Cl. G06K 9/00; G06K 9/62; G06T 15/20

(52) U.S. Cl. CPC G06K 9/00624; G06T 15/20; G06K 9/6215; G06K 9/6212

(57) ABSTRACT

An image processing apparatus for generating a virtual viewpoint image corresponding to a position and a direction of a virtual viewpoint obtains information related to the position and the direction of the virtual viewpoint, obtains a captured image from one or more cameras, determines whether the obtained camera image is to be used for generating the virtual viewpoint image, and generates, based on the captured image corresponding to the determination result, the virtual viewpoint image corresponding to the position and the direction of the virtual viewpoint.

### BACKGROUND OF THE INVENTION

### Field of the Invention

The present invention relates to an image processing apparatus and an image processing method.

### Description of the Related Art

Recently, a technique of performing synchronized image capturing by placing a plurality of cameras in different positions and generating a virtual viewpoint content by using a plurality of viewpoint images obtained by the image capturing operation is gaining attention. Since such a technique of generating a virtual viewpoint content allows, for example, a scene capturing the highlight of a soccer game or a basketball game to be viewed from various angles, a user can enjoy a realistic feel compared to a normal image. The generation of the virtual viewpoint content based on multi-viewpoint images is implemented by collecting images captured by the plurality of cameras in an image processing unit such as a server and causing the image processing unit to perform the processes such as rendering, three-dimensional shape model generation, and the like. Japanese Patent Laid-Open No. 2014-215828 discloses an arrangement in which a plurality of cameras are arranged to surround the same range, and images capturing the same range are used to generate a virtual viewpoint image.

Among the captured images obtained by such plurality of cameras as described above, there may be an image (inappropriate image) that should not be used for generating a virtual viewpoint image. For example, an image including a foreign object that adhered to the camera lens, an image including a spectator who stood up in front of the camera, an image including a flag waved by a cheerleading squad in front of the camera, and the like are examples of inappropriate images. A system capable of generating a virtual viewpoint image even when inappropriate images are included in the captured images of a plurality of cameras is desired.

### SUMMARY OF THE INVENTION

In consideration of the above problem, an embodiment of the present invention provides an image processing apparatus that can generate a virtual viewpoint image even in a case in which an inappropriate image, which should not be used to generate the virtual viewpoint image, is included in a plurality of captured images obtained by a plurality of cameras which has been placed for the generation of the virtual viewpoint image.

According to one aspect of the present invention, there is provided an image processing apparatus comprising: an obtainment unit configured to obtain a captured image from one or more cameras; a determination unit configured to determine whether the captured image obtained by the obtainment unit is not to be used for generating a virtual viewpoint image corresponding to a position and a direction of a virtual viewpoint; and a notification unit configured to notify a generation device, which is configured to generate the virtual viewpoint image, of information indicating a determination result by the determination unit.

According to another aspect of the present invention, there is provided an image processing method for generating a virtual viewpoint image corresponding to a position and a direction of a virtual viewpoint, the method comprising: obtaining information related to the position and the direction of the virtual viewpoint; obtaining a captured image from one or more cameras; determining whether the obtained captured image is to be used for generating the virtual viewpoint image; and generating, based on the captured image corresponding to the determination result, a virtual viewpoint image corresponding to the position and the direction of the virtual viewpoint.

According to another aspect of the present invention, there is provided a non-transitory computer-readable storage medium storing a program configured to cause a computer to execute an image processing method for generating a virtual viewpoint image corresponding to a position and a direction of a virtual viewpoint, the method comprising: obtaining information related to the position and the direction of the virtual viewpoint; obtaining a captured image from one or more cameras; determining whether the obtained captured image is to be used for generating the virtual viewpoint image; and generating, based on the captured image corresponding to the determination result, a virtual viewpoint image corresponding to the position and the direction of the virtual viewpoint.

Further features of the present invention will become apparent from the following description of exemplary embodiments (with reference to the attached drawings).

### BRIEF DESCRIPTION OF THE DRAWINGS

FIG. 1 is a block diagram of the arrangement of an image processing system that generates virtual viewpoint content according to an embodiment;

FIG. 2 is a block diagram showing an example of the arrangement of a camera adapter;

FIG. 3 is a block diagram for explaining image information processing in a camera adapter according to the first embodiment;

FIGS. 4A to 4C are views showing examples of a camera image, an object extraction image, and a background image, respectively;

FIGS. 5A to 5C are views showing examples of the camera image, the object extraction image, and the background image, respectively;

FIG. 6 is a flowchart showing processing of the camera adapter according to the first embodiment;

FIG. 7 is a sequence chart showing virtual camera image generation processing;

FIG. 8 is a flowchart showing processing by a virtual camera operation UI;

FIGS. 9A and 9B are views showing examples of a display screen on a virtual camera operation UI 330;

FIG. 10 is a view showing an example of the operation of a virtual camera;

FIG. 11 is a block diagram for explaining image information processing in a camera adapter according to the second embodiment;

FIG. 12 is a flowchart showing processing of the camera adapter according to the second embodiment; and

FIG. 13 is a flowchart showing processing of a camera adapter according to the third embodiment.

### DESCRIPTION OF THE EMBODIMENTS

### First Embodiment

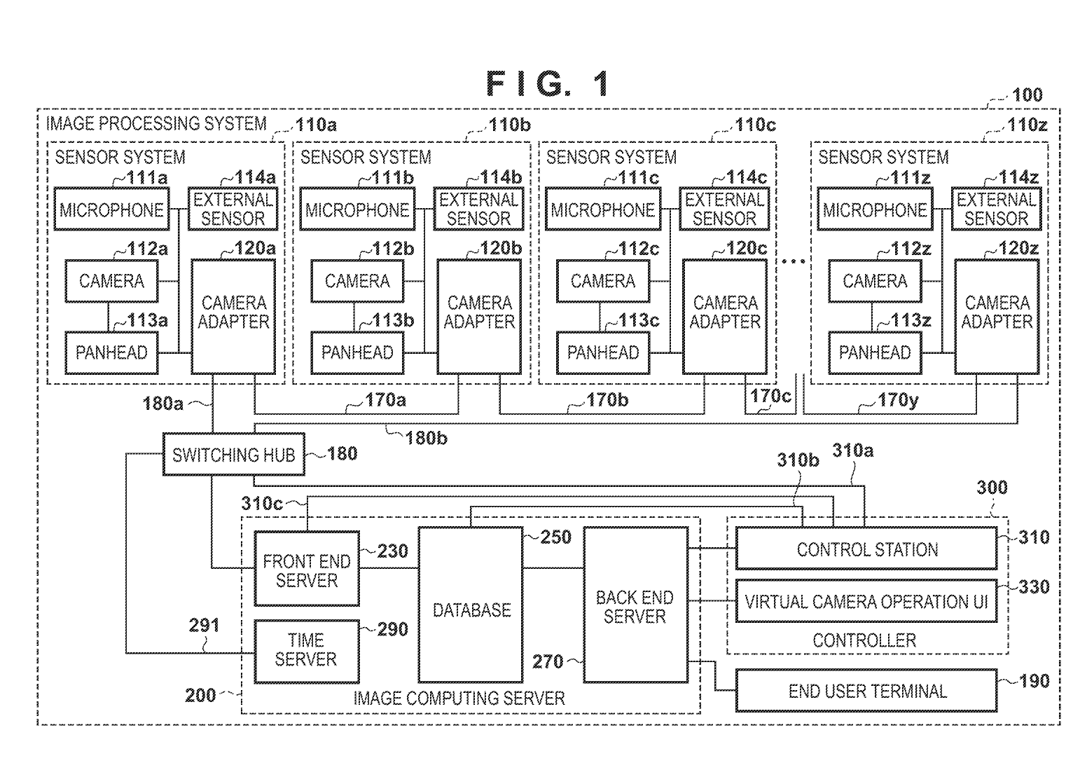

FIG. 1 is a block diagram showing an example of the arrangement of an image processing system 100. In the image processing system 100, image capturing and sound collection are performed by placing a plurality of cameras and microphones in a facility such as an arena (stadium) or a concert hall. The image processing system 100 includes sensor systems 110a to 110z, an image computing server 200, a controller 300, a switching hub 180, and an end user terminal 190. Each of camera adapters 120a to 120z, the image computing server 200, and the controller 300 is a computer device that includes a CPU and a memory. The operations of each of the camera adapters 120a to 120z, the image computing server 200, and the controller 300 to be described hereinafter can be implemented by the CPU executing a program stored in the memory in the device. Alternatively, some or all of the operations may be implemented by dedicated hardware.

The controller 300 is an information processing apparatus that includes a control station 310 and a virtual camera operation UI 330. The control station 310 performs management of operation states and parameter setting control for each block included in the image processing system 100 via networks 310a to 310c, 180a, 180b, and daisy chains 170a to 170y. Each network may be GbE (Gigabit Ethernet) or 10 GbE, which is Ethernet® complying with the IEEE standard, or may be formed by combining interconnect Infiniband, industrial Ethernet, and the like. The network is not limited to these, and may be a network of another type.

An operation of transmitting 26 sets of images and sounds obtained by the sensor systems 110a to 110z from the sensor system 110z to the image computing server 200 will be described. In the image processing system 100 according to this embodiment, the sensor systems 110a to 110z are connected by the daisy chains 170a to 170y.

In this specification, the 26 sensor systems 110a to 110z will be expressed as sensor systems 110 without distinction unless specifically stated otherwise. In a similar manner, in cases in which distinction is not particularly necessary, devices in each sensor system 110 will be expressed as a microphone 111, a camera 112, a panhead 113, an external sensor 114, and a camera adapter 120. Note that the number of sensor systems is described as 26. However, the number of sensor systems is merely an example and is not limited to this. Note that in this embodiment, a term “image” includes the concepts of both a moving image and a still image unless specifically stated otherwise. That is, the image processing system 100 according to this embodiment can process both a still image and a moving image. In this embodiment, an example in which a virtual viewpoint content provided by the image processing system 100 includes both a virtual viewpoint image and a virtual viewpoint sound will mainly be described. However, the present invention is not limited to this. For example, the virtual viewpoint content need not include a sound. Additionally, for example, the sound included in the virtual viewpoint content may be a sound collected by a microphone closest to the virtual viewpoint. In this embodiment, although a description of a sound will be partially omitted for the sake of descriptive simplicity, basically an image and a sound are processed together.

Each of sensor systems 110a to 110z according to this embodiment includes a corresponding one of cameras 112a to 112z. That is, the image processing system 100 includes a plurality of cameras to capture an object from a plurality of directions. The plurality of sensor systems 110 are connected to each other by a daisy chain. It is specified here that this connection form has the effect of decreasing the number of connection cables and saving labor in a wiring operation when increasing the image data capacity along with an increase in a captured image resolution to 4K or 8K and an increase in the frame rate. Note that the present invention is not limited to this, and as the connection form, the sensor systems 110a to 110z may be connected to the switching hub 180 to form a star network in which data transmission/reception among the sensor systems 110 is performed via the switching hub 180.

The sensor system 110a includes the microphone 111a, the camera 112a, the panhead 113a, the external sensor 114a, and the camera adapter 120a. Note that the arrangement is not limited to this, and the sensor system 110a suffices to include at least one camera adapter 120a and one camera 112a or one microphone 111a. For example, the sensor system 110a may be formed from one camera adapter 120a and a plurality of cameras 112a or formed from one camera 112a and a plurality of camera adapters 120a. That is, the plurality of cameras 112 and the plurality of camera adapters 120 in the image processing system 100 are in an N-to-M (N and M are integers of 1 or more) correspondence.

The camera adapter 120a performs image capturing processing. The external sensor 114a obtains information expressing the vibration of the camera 112a. The external sensor 114a can be, for example, formed by a gyro sensor or the like. The vibration information obtained by the external sensor 114a can be used by the camera adapter 120a to suppress the vibration in an image captured by the camera 112a. A sound collected by the microphone 111a and an image shot by the camera 112a undergo image processing (to be described later) by the camera adapter 120a and are then transmitted to the camera adapter 120b of the sensor system 110b via the daisy chain 170a. Similarly, the sensor system 110b transmits the collected sound and the captured image to the sensor system 110c together with the image and the sound obtained from the sensor system 110a.

Note that each sensor system 110 may include devices other than the microphone 111, the camera 112, the panhead 113, the external sensor 114, and the camera adapter 120. The camera 112 and the camera adapter 120 may be integrated. At least some functions of the camera adapter 120 may be imparted to a front end server 230. In this embodiment, assume that each of the sensor systems 110b to 110z has the same arrangement as that of the sensor system 110a. Note that all of the sensor systems 110 need not have the same arrangement, and the arrangement may change between the sensor systems 110.

The images and sounds obtained by the sensor systems 110a to 110z are transmitted from the sensor system 110z to the switching hub 180 via the network 180b and subsequently transmitted to the image computing server 200. Note that in this embodiment, each camera 112 is separated from each camera adapter 120. However, the camera and the camera adapter may be integrated in a single housing. In this case, the microphone 111 may be incorporated in the integrated camera 112 or may be connected to the outside of the camera 112.

The arrangement and the operation of the image computing server 200 will be described next. The image computing server 200 according to this embodiment processes the data (images and sounds obtained by the sensor systems 110a to 110z) obtained from the sensor system 110z. The image computing server 200 includes the front end server 230, a database 250, a back end server 270, and a time server 290.

The time server 290 has a function of distributing a time and synchronization signal, and distributes a time and synchronization signal to the sensor systems 110a to 110z via the switching hub 180. Upon receiving the time and synchronization signal, the camera adapters 120a to 120z implement image frame synchronization by genlocking the cameras 112a to 112z based on the time and synchronization signal. That is, the time server 290 synchronizes the image capturing timings of the plurality of cameras 112. Accordingly, since the image processing system 100 can generate a virtual viewpoint image based on the plurality of images captured at the same timing, lowering of the quality of the virtual viewpoint image caused by a shift in image capturing timings can be suppressed. Note that in this embodiment, the time server 290 manages the time synchronization of the plurality of cameras 112. However, the present invention is not limited to this, and the cameras 112 or camera adapters 120 may independently perform processing for the time synchronization.

The front end server 230 reconstructs a segmented transmission packet from an image and sound obtained from the sensor system 110z, converts the packet into data of a data format, and writes it in the database 250 in accordance with a camera identifier, data type, and frame number. The back end server 270 reads out, based on a viewpoint received from the virtual camera operation UI 330, corresponding image and sound data from the database 250 and performs rendering processing, thereby generating a virtual viewpoint image.

Note that the arrangement of the image computing server 200 is not limited to this. For example, at least two of the front end server 230, the database 250, and the back end server 270 may be integrated. In addition, at least one of the front end server 230, the database 250, and the back end server 270 may include a plurality of devices. A device other than the above-described devices may be included at an arbitrary position in the image computing server 200. Furthermore, at least some of the functions of the image computing server 200 may be imparted to the end user terminal 190 or the virtual camera operation UI 330.

An image which has undergone the rendering processing is transmitted from the back end server 270 to the end user terminal 190. As a result, a user who operates the end user terminal 190 can view an image and listen to the sound according to the designated viewpoint. That is, the back end server 270 generates a virtual viewpoint content based on the viewpoint information and the images (multi-viewpoint images) captured by the plurality of cameras 112. More specifically, the back end server 270 generates a virtual viewpoint content based on the viewpoint designated by user operation and the image data of a predetermined region extracted by the plurality of camera adapters 120 from the captured images obtained by the plurality of cameras 112. The back end server 270 provides the generated virtual viewpoint content to the end user terminal 190. Details of predetermined region extraction performed by the camera adapter 120 will be described later.

The virtual viewpoint content according to this embodiment is a content including a virtual viewpoint image as an image obtained when an object is captured from a virtual viewpoint. In other words, the virtual viewpoint image can be said to be an image representing a sight from a designated viewpoint. The virtual viewpoint may be designated by the user or may be automatically designated based on a result of image analysis or the like. That is, the virtual viewpoint image includes an arbitrary viewpoint image (free-viewpoint image) corresponding to a viewpoint arbitrarily designated by the user. The virtual viewpoint image also includes an image corresponding to a viewpoint designated by the user from a plurality of candidates or an image corresponding to a viewpoint automatically designated by the device.

Note that in this embodiment, an example in which a virtual viewpoint content includes sound data (audio data) will mainly be described. However, sound data need not always be included. The back end server 270 may compression-code the virtual viewpoint image by a standard technique represented by H.264 or HEVC and then transmit the virtual viewpoint image to the end user terminal 190 using the MPEG-DASH protocol. The virtual viewpoint image may be transmitted to the end user terminal 190 in a non-compressed state. In particular, the end user terminal 190 is assumed to be a smartphone or a tablet in the former case in which compression coding is performed, and is assumed to be a display capable of displaying a non-compressed image in the latter case. That is, the back end server 270 can switch the image format in accordance with the type of the end user terminal 190. The image transmission protocol is not limited to MPEG-DASH. For example, HLS (HTTP Live Streaming) or any other transmission method is usable. Note that the arrangement is not limited to this. For example, the virtual camera operation UI 330 can also directly obtain images from the sensor systems 110a to 110z.

In the image processing system 100, the back end server 270 thus generates a virtual viewpoint image based on image data obtained by capturing an object from a plurality of directions by the plurality of cameras 112. Note that the image processing system 100 according to this embodiment is not limited to the above-described physical arrangement and may have a logical arrangement.

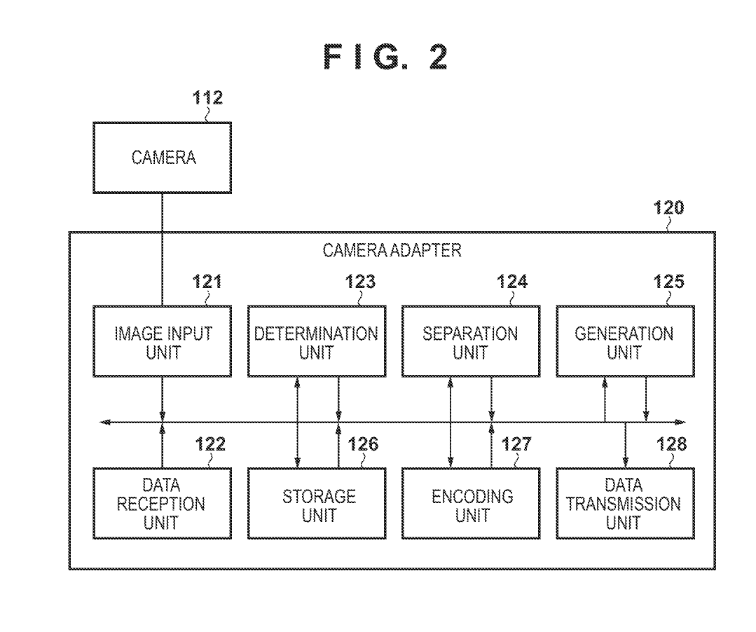

An example of the arrangement of the camera adapter 120 according to this embodiment will be described next with reference to FIG. 2. The camera adapter 120 includes an image input unit 121, a data reception unit 122, a determination unit 123, a separation unit 124, a generation unit 125, a storage unit 126, an encoding unit 127, and a data transmission unit 128.

The image input unit 121 is an input interface corresponding to a standard such as SDI (Serial Digital Interface). The image input unit 121 receives an image (camera image) captured by the camera 112 which serves as an image capturing unit and is connected to the camera adapter 120, and the image input unit writes the received image in the storage unit 126. The image input unit 121 also captures ancillary data to be superimposed on the SDI. The ancillary data includes a time code and camera parameters such as the zoom ratio, exposure, and color temperature. The ancillary data is used by each processing block included in the camera adapter 120.

The data reception unit 122 is connected to the camera adapter 120 of the upstream sensor system 110. The data reception unit receives a foreground image (to be referred to as an upstream foreground image hereinafter), a background image (to be referred to as an upstream background image hereinafter), three-dimensional shape model information (to be referred to as upstream three-dimensional shape model information hereinafter), and the like generated by the camera adapter 120 on the upstream side. The data reception unit 122 writes these received data in the storage unit 126. Note that the foreground image (upstream foreground image) is also called an object extraction image (upstream object extraction image).

The determination unit 123 determines whether a camera image is an image unsuitable for generating a virtual viewpoint image content. An image unsuitable for generating a virtual viewpoint image content corresponding to a position and a direction of a virtual viewpoint will be called an inappropriate image hereinafter. The determination unit 123 determines whether the camera image is an inappropriate image by using a camera image and an upstream object extraction image stored in the storage unit 126, a background image generated by the separation unit 124, and the like. Each processing block included in the camera adapter 120 and the controller 300, via a network, are notified of the determination result. Information indicating the determination of an inappropriate image will be referred to as information of inadequacy hereinafter.

The separation unit 124 separates a camera image into a foreground image and a background image. The separation unit 124 included in the camera adapter 120 extracts a predetermined region from a captured image obtained by the corresponding camera 112 of the plurality of the cameras 112. The predetermined region is, for example, a foreground image obtained by an object detection result corresponding to the captured image. This extraction allows the separation unit 124 to separate the captured image into a foreground image and a background image. Note that the object is, for example, a person. However, the object may be a specific person (a player, a coach, and/or a referee) or an object such as a ball or goal with a predetermined image pattern. A moving body may be detected as the object.

As described above, when a foreground image including an important object such as a person and a background image that does not include such an object are separated and processed, the quality of the image of a portion corresponding to the object in a virtual viewpoint image generated by the image processing system 100 can be improved. Note that a person may be included in a background image. A typical example of a person included in a background image is a spectator. A case in which the referee is not extracted as an object can also be considered. In addition, when the separation of the foreground image and the background image is performed by the camera adapter 120, the load in the image processing system 100 including the plurality of cameras 112 can be distributed. Note that the predetermined region is not limited to a foreground image and may be, for example, a background image.

The generation unit 125 generates image information (to be referred to as three-dimensional shape model information hereinafter) concerning the three-dimensional shape model by using the foreground image separated by the separation unit 124 and the upstream foreground image stored in the storage unit 126 and using, for example, the principle of a stereo camera. The storage unit 126 is a storage device, for example, a magnetic disk such as a hard disk, a non-volatile memory, or a volatile memory. The storage unit 126 stores a camera image, a foreground image, a background image, a program, images received from upstream camera adapters via the data reception unit 122, and the like. The above-described foreground image and background image generated by the separation unit 124 and the three-dimensional shape model information generated by the generation unit 125 are used to generate a virtual viewpoint content. That is, the separation unit 124 and the generation unit 125 are examples of processing units that obtain processed information by performing, on the obtained captured image, a part of the generation processing for generating a virtual viewpoint image by using a plurality of captured images obtained by the plurality of image capturing devices. In this embodiment, processed information includes a foreground image, a background image, and three-dimensional shape model information.

The encoding unit 127 performs compression-coding processing on an image captured by a self-camera. The compression-coding processing is performed by using a standard technique represented by JPEG or MPEG. The data transmission unit 128 is connected to the camera adapter 120 of the downstream sensor system 110 and transmits the camera image, the foreground image, the background image, and the three-dimensional shape model information that have undergone the compression-coding processing, and the images received from the upstream camera adapters.

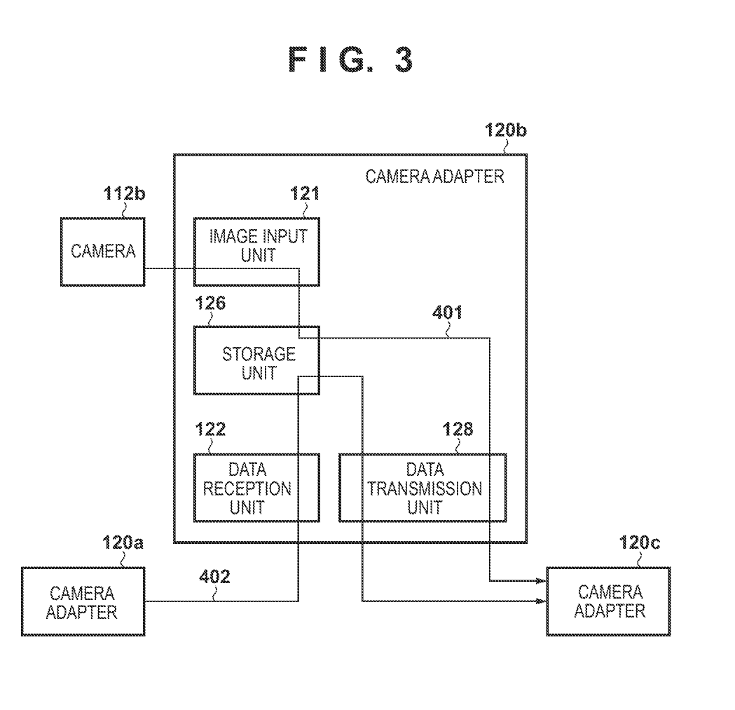

The manner in which image information is processed by the camera adapter 120b of the sensor system 110b will be described next with reference to FIG. 3. A path 401 indicates a path in which image information input from the camera 112b is processed, and a path 402 indicates a path in which data received from the camera adapter 120a is processed.

Image information input from the camera 112b is input to the camera adapter 120b via the image input unit 121, and the input image information is temporarily stored (path 401) in the storage unit 126 of the camera adapter 120b. The stored image information is used in the processes executed in the determination unit 123, the separation unit 124, the generation unit 125, and the encoding unit 127 as described in FIG. 2. The pieces of image information generated by the separation unit 124, the generation unit 125, and the encoding unit 127 are also stored in the storage unit 126. Data from the camera adapter 120a is input to the camera adapter 120b via the data reception unit 122 and is temporarily stored (path 402) in the storage unit 126. Data from the camera adapter 120a stored in the storage unit 126 is used, for example, by the generation unit 125 to generate the three-dimensional shape model information and the like. The foreground image, the background image, the three-dimensional shape model information generated from the camera image, and the images received from the upstream camera adapter 120a stored in the storage unit 126 are output (paths 401 and 402) to the downstream camera adapter 120c via the data transmission unit 128.

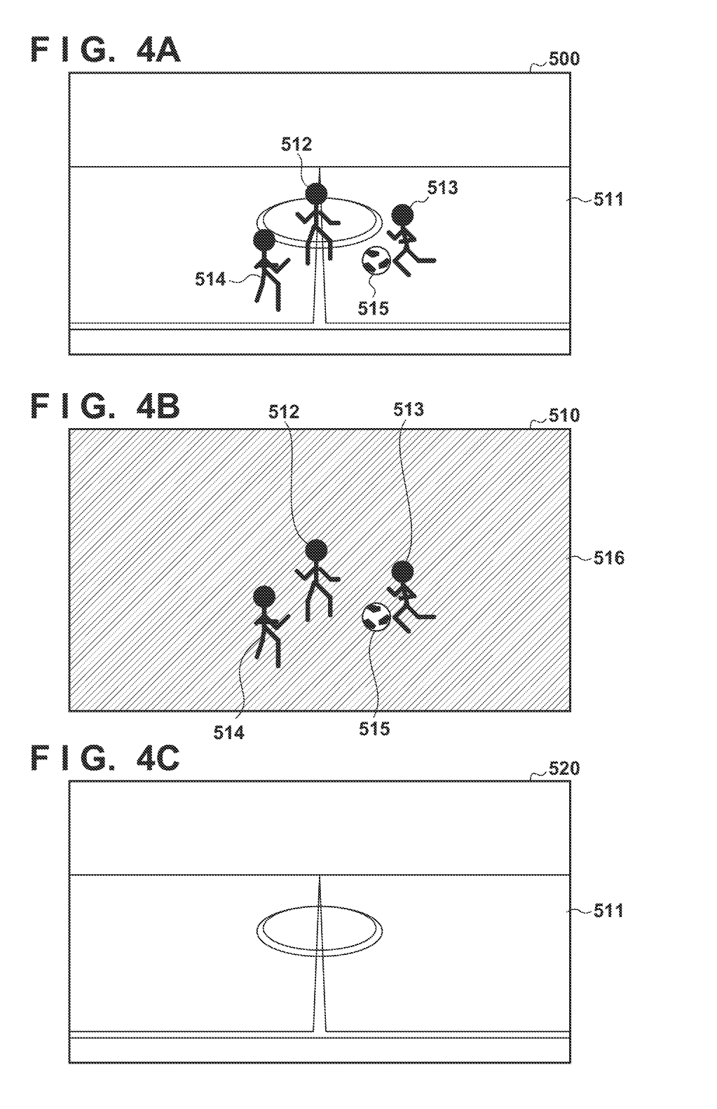

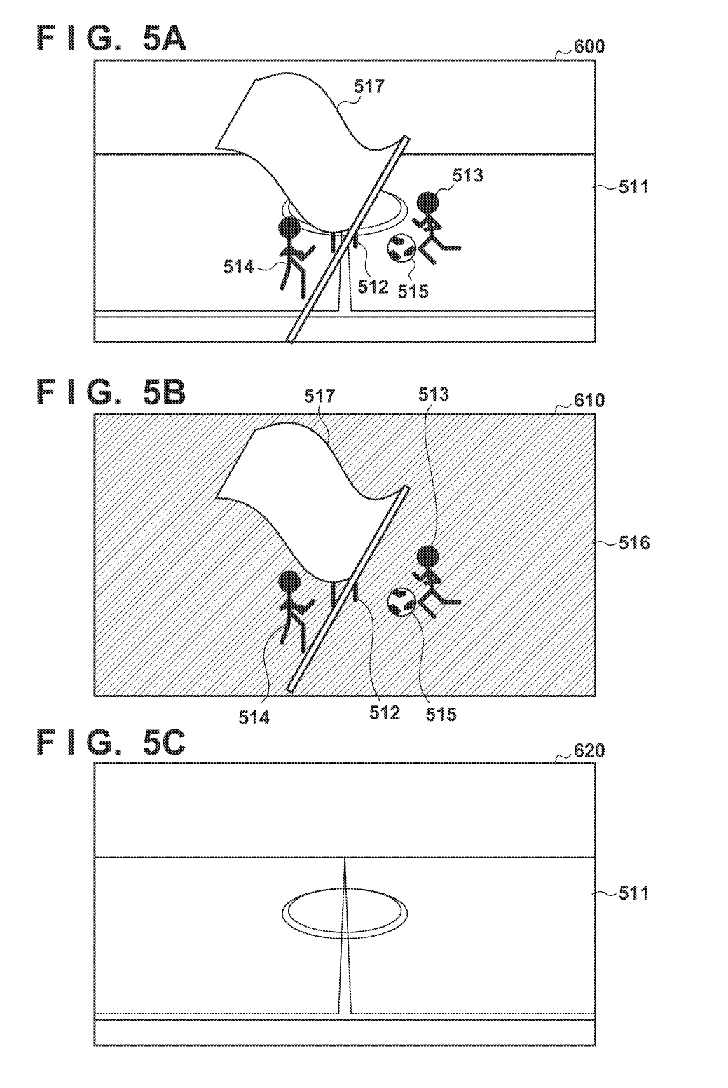

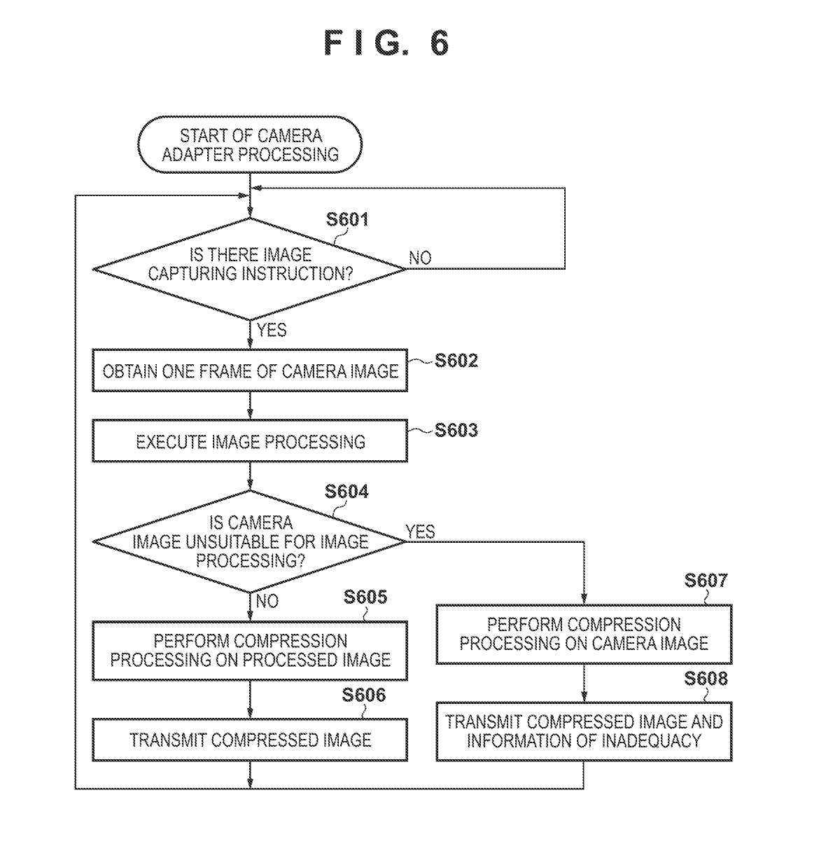

Processing performed in the camera adapter 120 in a case in which a camera image is determined to be an image (inappropriate image) unsuitable for generating a virtual viewpoint content by the determination unit 123 will be described next with reference to images shown in FIGS. 4A to 4C and FIGS. 5A to 5C and the flowchart shown in FIG. 6.

FIGS. 4A to 4C show examples of an image captured by the camera 112a, a foreground image (object image), and a background image generated by the camera adapter 120a. A camera image 500 captured by the camera 112a as shown in FIG. 4A includes a field 511, a player 512, a player 513, a player 514, and a ball 515 as objects. The separation unit 124 separates and generates, from the camera image 500 shown in FIG. 4A, a foreground image 510 shown in FIG. 4B and a background image 520 shown in FIG. 4C, and stores the generated foreground and background images in the storage unit 126. Assume that the foreground image 510 includes only the player 512, the player 513, the player 514, and the ball 515 as the objects, and that a background portion 516 is filled by a single color such as black. On the other hand, in the background image 520, the player 512, the player 513, the player 514, and the ball 515 as the objects have been removed from the camera image 500, and the field 511 has been reproduced and included in the image.

The manner in which a captured image is processed by the camera adapter 120 will be described below with reference to the flowchart shown in FIG. 6. First, as shown in FIGS. 4A to 4C, a case in which an image obtained from the camera 112 is not an inappropriate image will be described.

In the camera adapter 120, upon receiving (step S601) an instruction (image capturing instruction) to execute image capturing by the camera 112, the image input unit 121 obtains one frame of an image (camera image) from the camera 112 (step S602). Note that the image capturing instruction can be received from, for example, the data reception unit 122. The separation unit 124 executes image processing to generate the foreground image 510 and the background image 520 from the camera image and stores the generated foreground image and background image in the storage unit 126 (step S603). Next, the determination unit 123 determines whether the camera image is an inappropriate image unsuitable for generating a virtual viewpoint content (step S604). If it is determined that the camera image is not an inappropriate image (NO in step S604), the encoding unit 127 executes compression-coding processing on the foreground image 510 and the background image 520 obtained in step S604 (step S605). The foreground image 510 and the background image 520 which have been compression-coded are segmented, together with the sound data, into packets of a size defined by the transmission protocol by the data transmission unit 128, and the segmented data packets are output to a sensor system of the subsequent stage (step S606).

An example of processing in a case in which an image obtained from the camera 112 is not an inappropriate image has been described above. An example of processing in a case in which an image obtained from the camera 112 is an inappropriate image will be described next with reference to FIGS. 5A to 5C and FIG. 6.

FIGS. 5A to 5C are views showing examples of images in a case in which the camera image is determined to be an inappropriate image. FIGS. 5A, 5B, and 5C show a camera image, a foreground image, and a background image, respectively. A camera image 600 captured by the camera 112b shown in FIG. 5A includes, in the same manner as that in the camera image 500 of the camera 112a shown in FIG. 4A, the field 511 and objects such as the player 512, the player 513, the player 514, and the ball 515, and a flag 517. The separation unit 124 generates, from the camera image 600 shown in FIG. 5A, a foreground image 610 shown in FIG. 5B and a background image 620 shown in FIG. 5C and stores the generated foreground image and background image in the storage unit 126. The foreground image 610 includes only the flag 517, the player 512, the player 513, the player 514, and the ball 515 as objects, and a background portion 616 is filled by a single color such as black. In the background image 620, the flag 517, the player 512, the player 513, the player 514, and the ball 515 as objects have been removed from the camera image 600, and the field 511 has been reproduced and included in the image.

In the example of FIG. 5A, in the camera image 600 captured by the camera 112, the flag 517 which is being waved near the camera 112b has been captured. Hence, the flag 517 overlaps the player 512 and hides the player 512. As a result, if a virtual viewpoint content, particularly a virtual viewpoint content of the player 512, is to be generated by using the foreground image 610 generated by the camera adapter 120b, a corrupted content will be generated. Therefore, the determination unit 123 will determine that the camera image 600 is an inappropriate image (NO in step S604).

If the camera image 600 is determined to be an inappropriate image, the encoding unit 127 performs compression-coding processing on the camera image obtained from the camera 112 (step S607). The compression-coded image is segmented, together with the sound data and the information of inadequacy by the determination unit 123, into packets of a size defined by a transmission protocol and output via the data transmission unit 128 (step S608). In this manner, in a case in which it is determined that the camera image is an inappropriate image, the camera adapter 120 according to this embodiment adds the information of inadequacy to the camera image (inappropriate image) and transmits the image to the downstream camera adapter 120.

Thus, predetermined information of inadequacy is added to image data corresponding to a captured image that has been determined by the determination unit 123 to be unusable for generating a virtual viewpoint image, and the information-of-inadequacy-added image data is transmitted to a generation device used for generating the virtual viewpoint image. In this embodiment, the image computing server 200 is used as the generation device. The inappropriate image is subsequently displayed on the controller 300. Such an arrangement has an effect of allowing the user of the controller 300 to visually confirm in what way the image is an inappropriate image as well as why the image has been determined to be an inappropriate image. In addition, in a case in which the determination result indicating an inappropriate image is an error, the user can cancel the inappropriate image determination. However, neither the transmission of the inappropriate image by the camera adapter 120 nor the cancellation of the inappropriate image determination is essential to the arrangement.

In step S608, it is preferable to reduce the transmission data amount of the compression-coded captured image (inappropriate image) transmitted from the data transmission unit 128 more than the transmission data amount of the processed information (foreground image, background image, and three-dimensional shape model information). This is because it allows the transmission of pieces of image information (processed information) from other cameras to be prioritized. This can be implemented by, for example, compressing the inappropriate image at a compression rate higher than that for other images in the encoding unit 127. Alternatively, it can be implemented by causing the data transmission unit 128 to transmit the inappropriate image at a frame rate lower than the frame rate for processed information. Alternatively, these implementation methods may be combined. The parameter for compressing the inappropriate image may be a predetermined parameter or may be dynamically determined so that the compressed data amount will be a predetermined data amount or less.

Determination, by the determination unit 123, as to whether a camera image is an image (inappropriate image) unsuitable for generating a virtual viewpoint content will be described. For example, the determination unit 123 may determine, based on a comparison result of captured images obtained from two or more cameras, whether a captured image of one or more cameras is not to be used for generating a virtual viewpoint image. For example, the determination unit 123 determines whether a captured image of one or more cameras is not to be used for generating a virtual viewpoint image based on one or a combination of
(a determination method 1) a difference between the size of an object detected from a captured image of a first camera and the size of an object detected from a captured image of a second camera,
(a determination method 2) a pixel count in which a difference between the pixel values of the captured image of the first camera and the pixel values of the captured image of the second camera is equal to or more than a threshold, and
(a determination method 3) a comparison of statistical information related to the pixel values of the captured image of the first camera and the pixel values of the captured image of the second camera.

For example, if the image shown in FIG. 4A is the image obtained by an upstream camera adapter, the determination by the determination unit 123 is performed in the following manner. That is, the determination unit 123 compares the foreground image (FIG. 4B) transmitted from the upstream camera adapter and the foreground image (FIG. 5B) generated from the camera image. Whether the camera image is an inappropriate image is determined by, for example, a pixel count of unmatched pixel values (an application example of the determination method 2), a difference between statistical information (for example, a luminance histogram or the like) of the pixel values (an application example of the determination method 3), a change in the size of the foreground image (an application example of the determination method 1), or the like. In addition, two or more determination methods among these methods may be combined.

Also, detection processing for detecting a specific object from a captured image (camera image) may be executed, and a captured image in which the specific object is detected may be determined to be an inappropriate image unsuitable for generating a virtual viewpoint image. For example, the image pattern of a specific object such as a flag or a spectator may be stored beforehand, and an inappropriate image may be determined based on the detection result of the image pattern in the captured image. Also, it may be arranged so that, among an object of a size equal to or more than a threshold and an object that does not include the predetermined image pattern, an object satisfying at least one of the conditions is determined as a specific object. Alternatively, the determination unit 123 can recognize an object that moves at a speed equal to or more than a threshold as a specific object, and determine whether the captured image is an inappropriate image.

As another example of a determination method of an inappropriate image, a determination may be made based on a temporal difference with a preceding captured image. For example, it can be arranged so that a first captured image obtained at a first time and a second captured image obtained at a second time later than the first time are compared, and the second captured image may be determined to be an inappropriate image if the average luminance or color differs from that of the first captured image. Also, for example, an inappropriate image may be determined based on a sensing result of the external sensor 114 (for example, a vibration sensor) included in the sensor system 110.

FIG. 5A shows an example of an image in which the player 512 is hidden by the flag 517 as an image unsuitable for generating a virtual viewpoint content. However, other than a case in which an obstacle is captured in front of an object, the following cases can also be considered. For example, a case in which a piece of dust or a water droplet has attached to the lens of the camera 112, a case in which only an entirely black screen image is output from the camera 112 due to failure of the camera 112, a case in which the synchronization signal in the camera 112 fluctuates and only noise or an image flowing in a vertical direction is output, and the like can be assumed.

Returning to the description of FIG. 1, the image computing server 200 accumulates the data obtained from the sensor system 110z in the database 250. The back end server 270 receives the designation of a viewpoint from the virtual camera operation UI 330, generates a virtual viewpoint image by performing rendering processing based on the received viewpoint, and transmits the generated virtual viewpoint image to the end user terminal 190.

For example, the back end server 270 generates a virtual viewpoint image based on the three-dimensional shape model information. Such an image generation method is called model-based rendering. As described above, in this embodiment, the camera adapter 120 generates the three-dimensional shape model information. At this time, the three-dimensional shape model information is generated by using each captured image other than a captured image which has been determined as unusable for generating a virtual viewpoint image by the inappropriate image determination. Note that, for example, the front end server 230 may generate the three-dimensional shape model information from captured images other than a captured image determined to be an inappropriate image. The generation method of a virtual viewpoint image is also not limited to model-based rendering. For example, among captured images other than a captured image determined to be unusable for generating a virtual viewpoint image, the back end server 270 may generate a virtual viewpoint image by performing composition processing on one or a plurality of captured images specified based on the position and direction of the virtual viewpoint. Such an image generation method is called image-based rendering. The virtual camera operation UI 330 receives the virtual viewpoint image from the back end server 270 and displays the image.

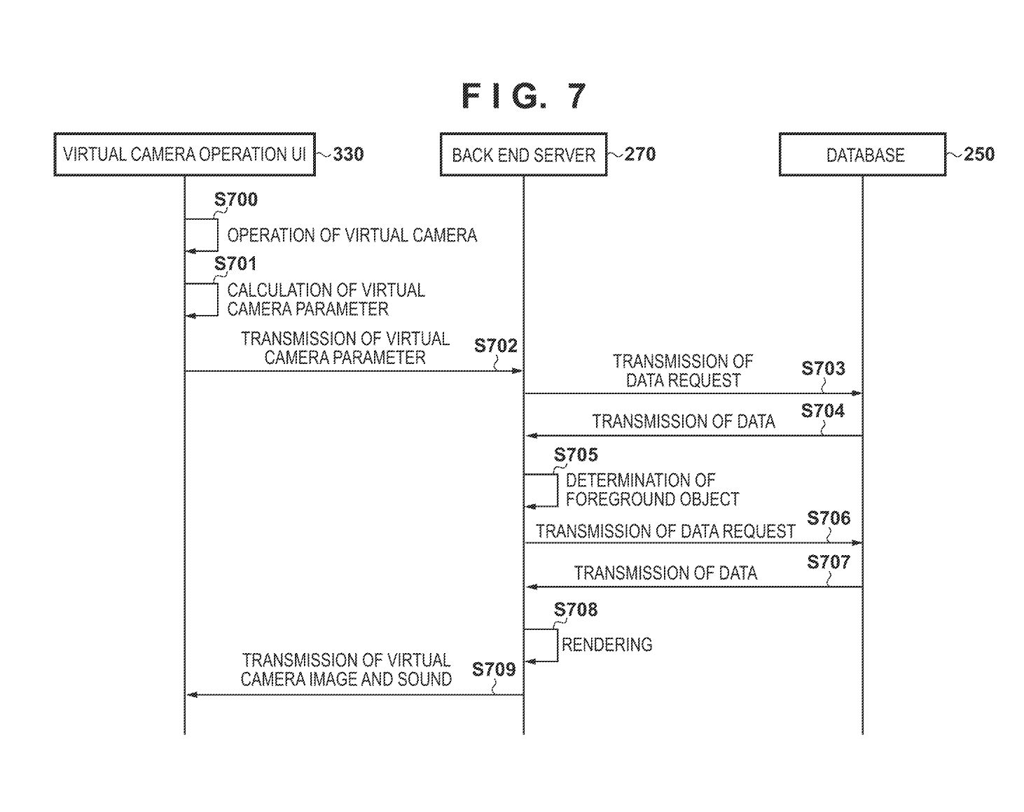

FIG. 7 shows a sequence of processing, from the operation of an input device by an operator until the display of a virtual camera image, to be executed by the virtual camera operation UI 330, the back end server 270, and the database 250. The virtual camera operation UI 330 performs display control to cause the display device to display a virtual viewpoint image obtained from the generation processing for generating the virtual viewpoint image based on the setting of a virtual viewpoint, the virtual viewpoint and the plurality of captured images obtained from the plurality of sensor systems that include image capturing devices. Here, the back end server 270 executes the generation processing of generating a virtual viewpoint image.

First, the operator operates the virtual camera operation UI 330 to operate a virtual camera (S700). For example, a joystick, a jog dial, a touch panel, a keyboard, a mouse, or the like can be used as an input device of the virtual camera operation UI 330. The virtual camera operation UI 330 calculates virtual camera parameters representing the position and orientation of the input virtual camera (S701). The virtual camera parameters include external parameters indicating the position and the orientation of the virtual camera and an internal parameter indicating zoom ratio of the virtual camera. The virtual camera operation UI 330 transmits the calculated virtual camera parameters to the back end server 270 (S702).

Upon receiving the virtual camera parameters, the back end server 270 transmits a request to the database 250 for pieces of three-dimensional shape model information (S703). In response to the request, the database 250 transmits, to the back end server 270, the pieces of three-dimensional shape model information including the position information of a foreground object (S704). The back end server 270 geometrically calculates objects in the field of view of the virtual camera from the position information of each object included in the virtual camera parameters and the pieces of three-dimensional shape model information (S705). The back end server 270 transmits a request for foreground images, the pieces of three-dimensional shape model information, background images, and sets of sound data of the respective calculated objects to the database 250 (S706). The database 250 transmits the data to the back end server 270 in response to the request (S707). Note that as the three-dimensional shape model information, the information received in the processes of S703 and S704 may be used. In such a case, reception of three-dimensional shape model information in S706 will be omitted.

The back end server 270 generates, from the foreground images and the pieces of three-dimensional shape model information received from the database 250, a foreground image and a background image of a virtual viewpoint and combines the generated foreground image and the background image to generate a virtual viewpoint image (S708). Combining of sound data corresponding to the position of the virtual camera from the sets of sound data is performed, and the combined sound data is integrated with the virtual viewpoint image to generate a virtual viewpoint content. The back end server 270 transmits the generated virtual camera image and sound to the virtual camera operation UI 330 (S709). The virtual camera operation UI 330 plays back and displays the image and sound received from the back end server 270. Thus, the playback of a virtual content in the virtual camera operation UI 330 is implemented.

According to an example described above, a flag being waved near the camera 112b hid a player in an image captured by the camera 112b (FIGS. 5A and 5B). Hence, the camera adapter 120b determines that this image is an inappropriate image unsuitable for generating a virtual viewpoint content, and the camera image (inappropriate image) that underwent compression processing is output together with the sound data and the information of inadequacy. As a result, the image computing server 200 reads out, from the database 250, data excluding the image from the sensor system 110b, and the virtual viewpoint image is generated by performing rendering processing by the back end server 270. Since the generated virtual viewpoint image is generated without using the image from the sensor system 110b, its resolution and sharpness degrade. That is, the image quality of a virtual viewpoint image which is generated from a case in which an inappropriate image has occurred will be degraded than that of a virtual viewpoint image generated by using all of the camera images. Hence, a rapid and appropriate measure is required to cope with the occurrence of an inappropriate image. As a response to such a requirement, this embodiment allows the user to specify the camera in which an inappropriate image has occurred and to observe the inappropriate image.

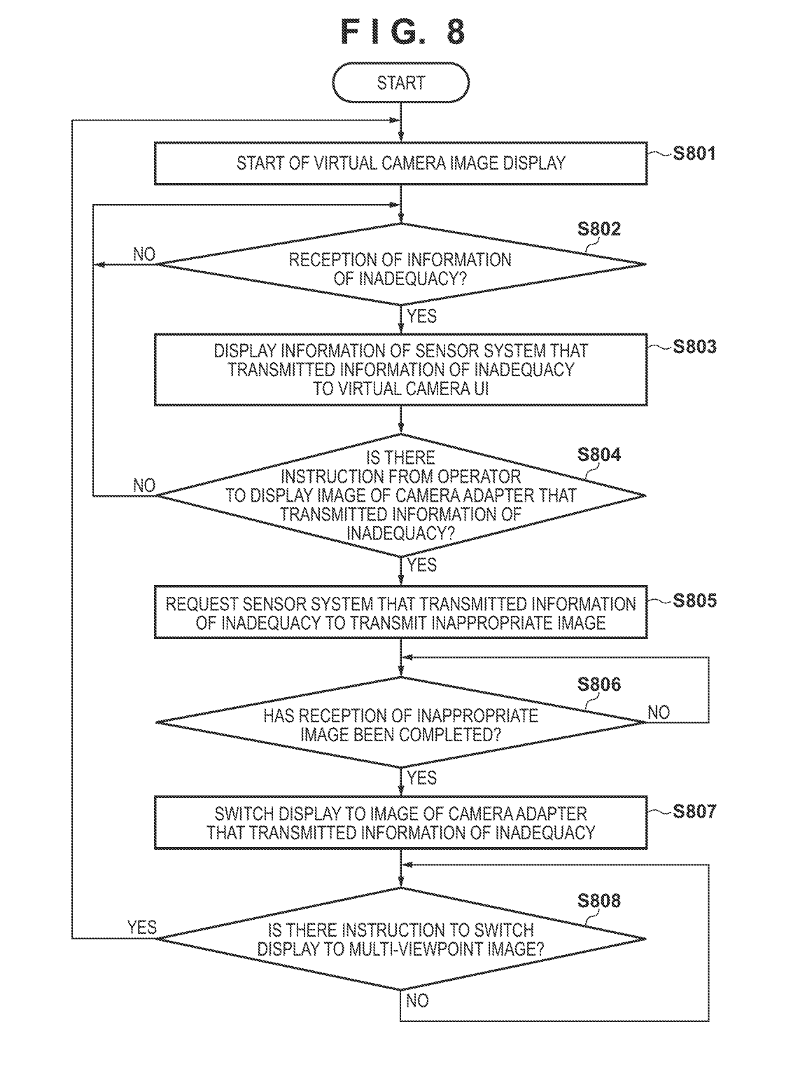

FIG. 8 is a flowchart showing processing, in the controller 300, when the sensor system 110 which has determined that a camera image is an inappropriate image unsuitable for generating a virtual viewpoint image is present. FIG. 8 shows processing to cause the virtual camera operation UI 330 to display, in place of displaying a virtual camera image, an image determined to be an inappropriate image in the sensor system.

First, the control station 310 instructs the start of virtual camera image display to the virtual camera operation UI 330, the back end server 270, and the database 250, and the virtual camera image display is started by the processing shown in FIG. 7 (step S801). The control station 310 determines whether the information of the sensor system 110 that transmitted the information of inadequacy, which indicates the occurrence of an inappropriate image, is present among the pieces of information of the sensor systems 110a to 110z transmitted via the network 180b (step S802). If there is no information of the sensor system that transmitted the information of inadequacy (NO in step S802), the control station 310 continues the virtual camera image display. If the information of inadequacy is detected (YES in step S802), the virtual camera operation UI 330 displays (step S803) the information indicating the sensor system that transmitted the information of inadequacy and notifies the operator of the transmission of the information of inadequacy.

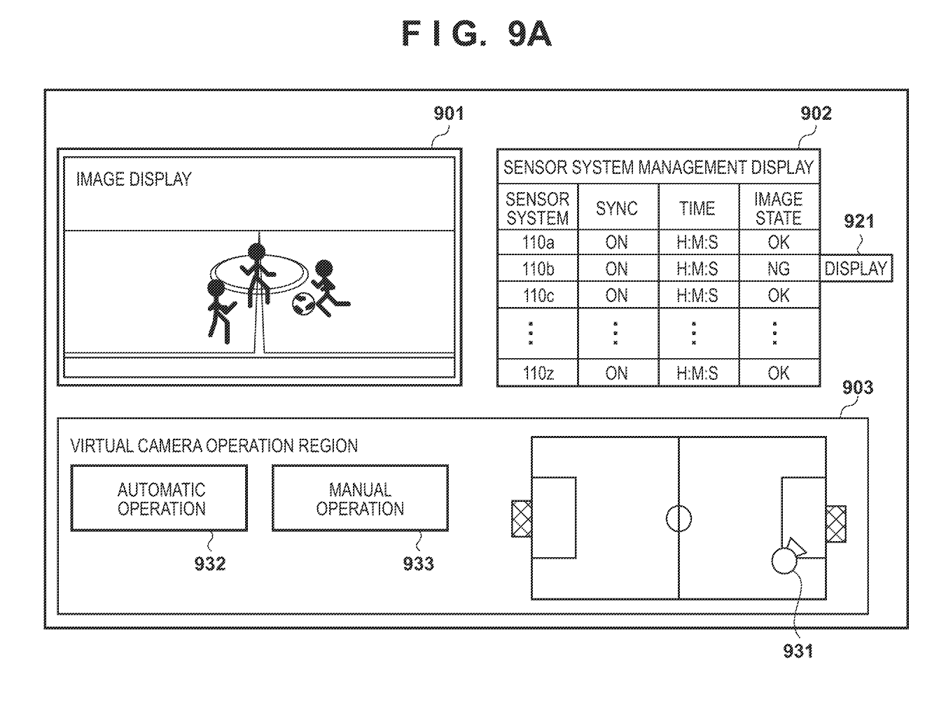

FIGS. 9A and 9B show examples of images to be displayed on the display screen included in the virtual camera operation UI 330. The display screen example shown in FIG. 9A is formed from the following three portions. The first portion is an image display unit 901 that displays a virtual camera image. The second portion is a sensor system management display unit (to be referred to as a management display unit 902 hereinafter) that displays the pieces of information of the sensor systems 110a to 110z received by the control station 310 via the network 180b. The third portion is a virtual camera operation region 903 to operate the virtual camera.

The virtual camera operation UI 330 sequentially displays, on the image display unit 901, each virtual camera image input from the back end server 270 so that the operator can confirm the virtual camera image which has been generated by the image computing server 200. The operator can obtain an image from a free viewpoint by operating a virtual camera 931 in the virtual camera operation region 903.

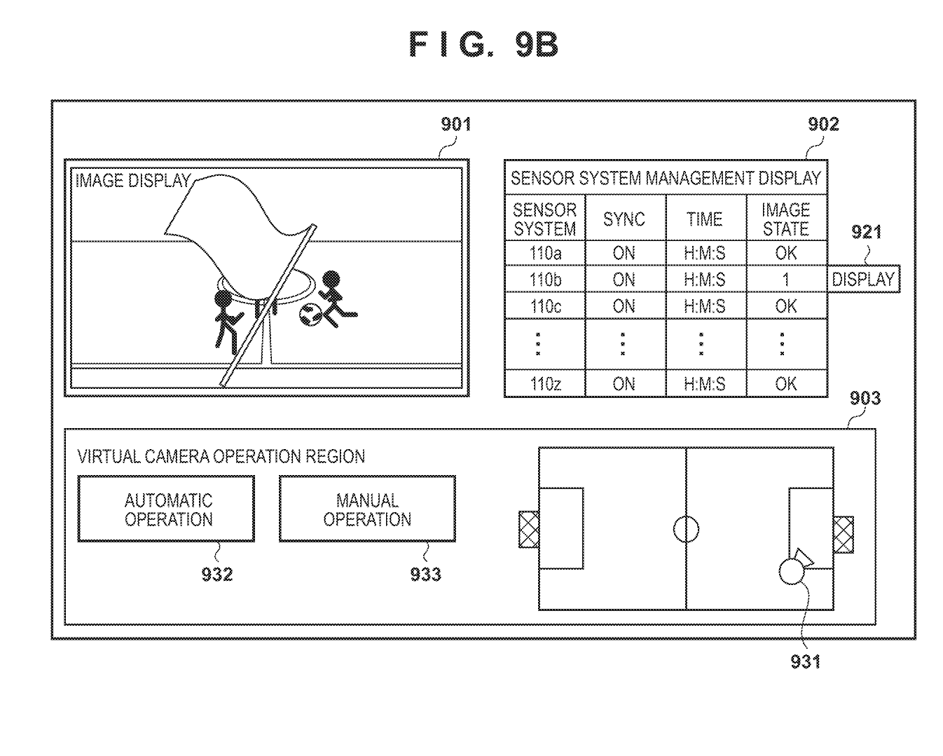

FIG. 10 is a schematic view showing an example of the operation of the virtual camera 931. The operator designates the position and orientation of the virtual camera 931 for each frame on a virtual camera path 1001. The virtual camera operation UI 330 calculates virtual camera parameters from the information of the designated virtual camera path 1001 and transmits the calculated parameters to the back end server 270. Here a time corresponding to the position of the virtual camera 931 is not limited to one frame, and an arbitrary time can be set by the operator. Other than the operator manually performing the operation of the virtual camera 931, it can be selected so that the virtual camera will be automatically operated in accordance with a predetermined virtual camera path. For example, a GUI (Graphical User Interface) buttons (an automatic operation button 932 and a manual operation button 933 in FIG. 9A) can be arranged to switch between manual operation and automatic operation.

FIG. 9A shows an example of the sensor system management display unit 902 when the information of inadequacy has been transmitted from the sensor system 110b. In this example, the sensor system management display unit 902 displays connected sensor systems, their respective synchronization states (SYNC), time information indicated by hour (H), minute (M), and second (S), and an image state field indicating the presence/absence of the transmission of information of inadequacy. In FIG. 9A, since the information of inadequacy has been transmitted from the sensor system 110b, the image state of the sensor system 110b is displayed as NG. Furthermore, in this example, it is possible to cause a camera image (inappropriate image) determined to be an image unsuitable for generating a virtual viewpoint content to be displayed in place of displaying the virtual camera image. The virtual camera operation UI 330 displays, together with the sensor system management display, a display button 921 for instructing this operation (step S803). The virtual camera operation UI 330 can make a notification of the reception of the information of inadequacy by “NG” in the image state field of the sensor system management display unit 902 and the appearance of the display button 921.

In the processing of FIG. 8, when the display button 921 is selected by the operator (user) (step S804), the virtual camera operation UI 330 outputs, to the back end server 270, a transmission request for the inappropriate image of the sensor system 110b (step S805). Upon receiving the transmission request for the inappropriate image of the sensor system 110b from the virtual camera operation UI 330, the back end server 270 requests the database 250 to output the inappropriate image of the sensor system 110b. When the inappropriate image of the sensor system 110b is transmitted from the database 250, the back end server 270 transmits the image information to the virtual camera operation UI 330.

The virtual camera operation UI 330 waits (step S806) for the inappropriate image of the sensor system 110b to be transmitted from the database 250. Upon completion of the reception of the inappropriate image, the virtual camera operation UI displays the inappropriate image of the sensor system 110b in place of the virtual camera image display (step S807). The display of the inappropriate image of the sensor system 110b is continued (NO in step S808) on the virtual camera operation UI 330 until the manual operation button 933 or the automatic operation button 932 is operated. When the manual operation button 933 or the automatic operation button 932 is operated by the operator, the display on the image display unit 901 is switched to the virtual camera image (YES in step S808 and step S801).

Note that the timing to switch the display to the virtual camera image is not limited to the operation by the operator, and the display may be switched to the virtual camera image when the transmission of the information of inadequacy from the sensor system 110b cannot be detected for a predetermined time. Also, in step S804, if the operator does not select the display button 921, the process returns to step S802 and the virtual camera operation UI waits for the reception of the information of inadequacy.

In this example, the virtual camera operation UI 330 includes a display screen, and the operator can confirm a camera image determined to be an image unsuitable for generating a virtual viewpoint content by displaying the determined camera image on the display screen. However, the present invention is not limited to this. The end user terminal 190 can be used to display the camera image determined to be an image unsuitable for generating a virtual viewpoint content. Furthermore, if the end user terminal 190 is to be used to display the camera image determined to be an image unsuitable for generating a virtual viewpoint content, the end user terminal 190 may include an operation UI unit.

Also, in this example, when the information of inadequacy is transmitted from the sensor system 110, “NG” is displayed in the image state field of the corresponding sensor system in the sensor system management display unit 902 on the display screen of the virtual camera operation UI 330. However, since the sensor system 110 already grasps the reason for the determination of an inappropriate image, a number, for example, can be assigned to the determination reason and transmitted as the information of inadequacy, and this number may be displayed on the virtual camera operation UI 330. For example, “1” can indicate a case in which an inappropriate image is determined because the area of the foreground image is larger than the area of a foreground image which has been transmitted from the upstream sensor system, and “2” can indicate a case in which failure of the camera 112 is detected.

FIG. 9B shows a state in which the inappropriate image captured by the camera 112b has been displayed by switching the virtual camera image display in response to the operation of the display button 921. Also, in FIG. 9B, “1” which has been obtained as the information of inadequacy is displayed in the sensor system management display unit 902. In the virtual camera operation UI 330, such display allows the operator to more easily specify the cause of the determination of the inappropriate image when the inappropriate image is displayed.

As described above, according to the first embodiment, in a case in which an image captured by a camera is determined to be an image (inappropriate image) unsuitable for generating a virtual viewpoint content, the image captured by the camera and the corresponding information of inadequacy are transmitted to the image computing server 200. In the virtual camera operation UI 330, the operator can make an instruction to display the inappropriate image in place of the generated virtual viewpoint content so that he/she can confirm the image that was determined to be an unsuitable image. As a result, the user can quickly grasp the cause of the determination of the unsuitability of the image for generating a virtual viewpoint image, and take measure accordingly.

### Second Embodiment

In the first embodiment, the camera adapter 120 determines whether a camera image is an inappropriate image unsuitable for generating a virtual viewpoint content. If the camera image is determined to be an inappropriate image, the inappropriate image and the information of inadequacy are transmitted to the server. As a result, the virtual camera operation UI 330 can display the inappropriate image in place of the generated virtual viewpoint content. In the second embodiment, whether an image captured by a camera is an image unsuitable for generating a virtual viewpoint content is determined, and the image captured by the camera and information of inadequacy are transmitted to a server if the image has been determined to be unsuitable over a predetermined period. Note that the arrangement of an image processing system 100 according to the second embodiment is the same as that in the first embodiment.

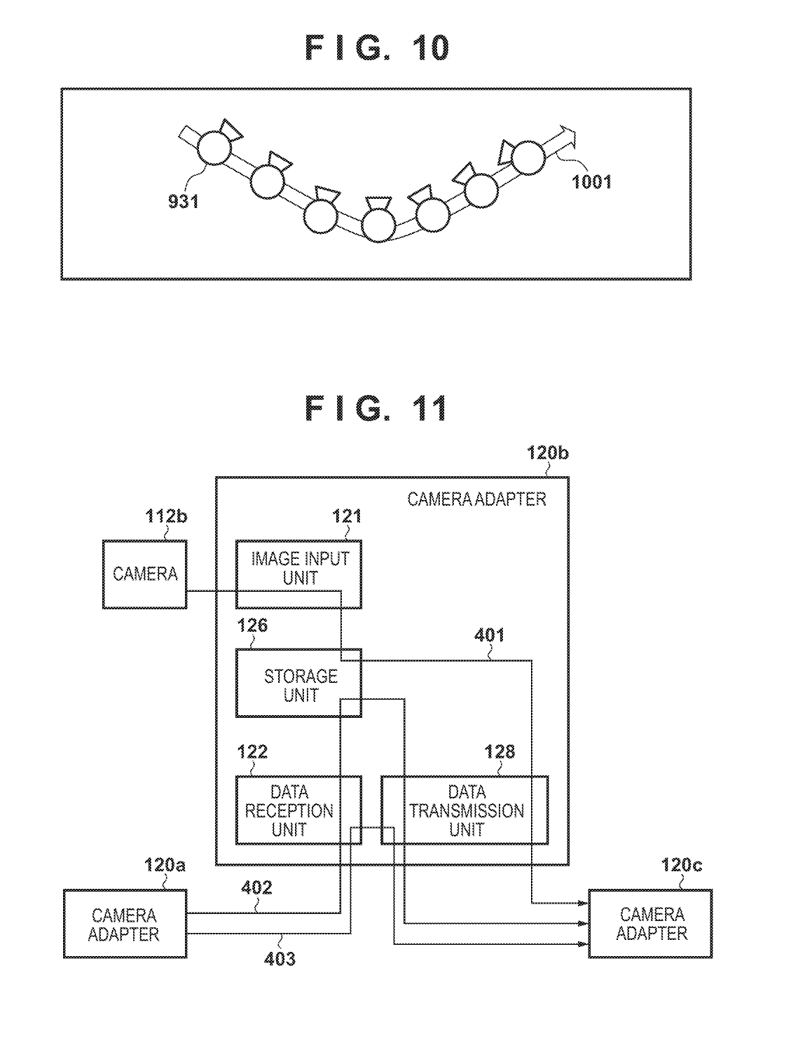

FIG. 11 is a block diagram explaining the manner in which image information is processed in a camera adapter 120b according to the second embodiment. In FIG. 11, a path 403 for bypassing image information from upstream has been added to image information paths 401 and 402 in the camera adapter 120b according to the first embodiment described in FIG. 3. That is, the camera adapter 120b according to the second embodiment has a function of transferring data, which has been received unconditionally, to a succeeding camera adapter 120c without storing the data received from a camera adapter 120a in a storage unit 126. This function will be called a bypass function hereinafter. The bypass function functions, for example, in cases in which the camera adapter 120b determines that the camera is in an image capturing stop state, a calibration state, or in an error processing state, or when operation failure occurs during processing of an image input unit 121 or the storage unit 126. In such cases, as shown by the path 403, images received via a data reception unit 122 are output intact to a data transmission unit 128 and transferred to the downstream camera adapter 120c.

Although unspecified in FIG. 11, a sub-CPU that detects that the image input unit 121 and the storage unit 126 are in an error state or a stopped state may be arranged in the camera adapter 120b, and the processing to perform bypass control may be added when the sub-CPU detects an error. This has an effect of allowing fault states and bypass control of each functional block to be controlled independently. Additionally, it may be arranged so that the camera adapter will shift to a normal transmission mode when the state of a camera 112 has shifted from the calibration state to the image capturing state or when the camera adapter has recovered from operation failure of the image input unit 121 or the storage unit 126. This function allows data to be transferred to the succeeding camera adapter 120c even when determination related to data routing cannot be made due to an occurrence of an unfortunate breakdown or the like.

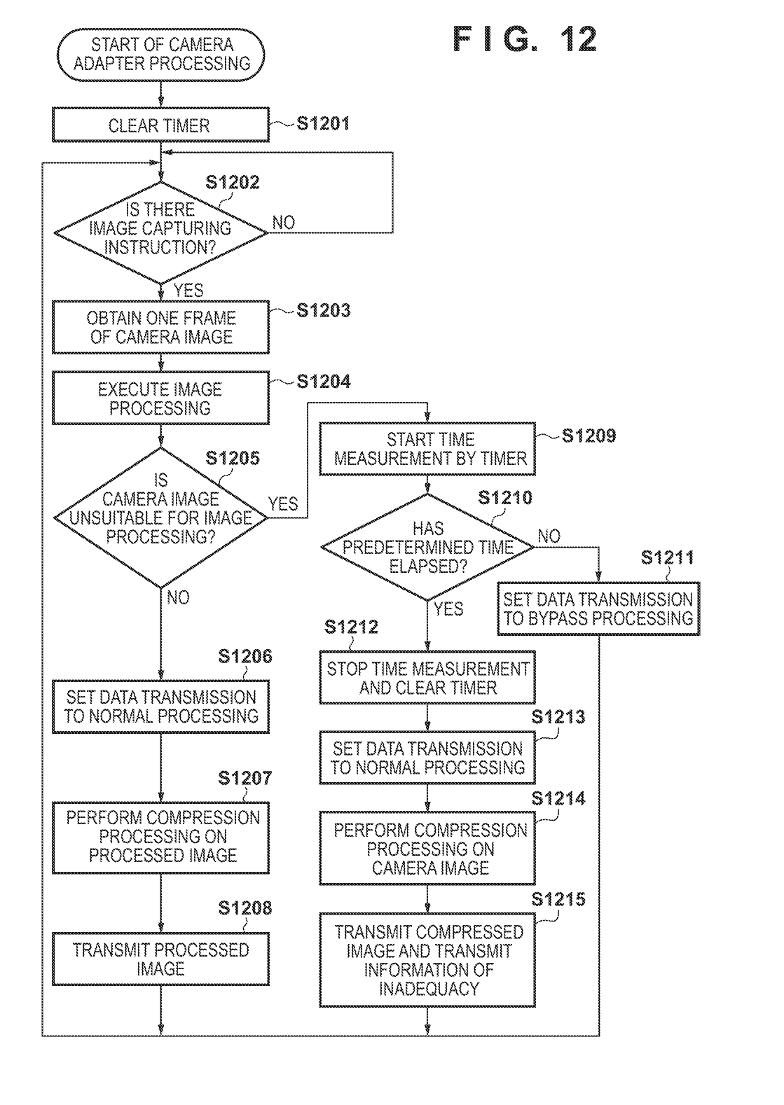

FIG. 12 is a flowchart showing processing in the camera adapter 120 according to the second embodiment.

In this example, the camera adapter 120 includes a timer (not shown) that measures time, and the timer is cleared at the start of the processing (step S1201). The processes of steps S1202 to S1204 are the same as those of steps S601 to S603 according to the first embodiment. That is, the camera adapter 120 responds to an image capturing instruction (step S1202), obtains one frame of an image (camera image) from the camera 112 (step S1203), generates a foreground image and a background image, and stores the generated images in the storage unit 126 (step S1204).

The determination unit 123 determines whether the camera image is an inappropriate image unsuitable for generating a virtual viewpoint content (step S1205). If it is determined that the camera image is not an inappropriate image, the data transmission unit 128 is set to a normal processing mode (step S1206). That is, it is set so that the path 401 to process the image information input from the camera 112 and the path 402 to process the data received from the upstream camera adapter 120 will be used. Compression processing is performed on the foreground image and the background image (step S1207), and the processed images and sound data are segmented into packets of a size defined by a transmission protocol and output via the data transmission unit 128 (step S1208).

If it is determined in step S1205 that camera image is an inappropriate image, the camera adapter 120b starts measuring time by the timer (step S1209) and determines whether a predetermined time has elapsed (step S1210). Note that if time measurement by the timer is being executed in step S1209, the camera adapter 120b causes the timer to continue measuring time. If it is determined in step S1210 that the predetermined time has not elapsed, the camera adapter 120b sets a bypass processing mode to use the path 403 to transmit, via the data transmission unit 128, the images received by the data reception unit 122 (step S1211). As a result, the camera adapter 120b transfers unconditionally, to the succeeding camera adapter 120c, the data received from the camera adapter 120a without storing the received data in the storage unit 126.

If it is determined in step S1210 that the predetermined time has elapsed, the camera adapter 120b stops time measurement by the timer and clears the value of the timer (step S1212). The camera adapter 120b sets the data transmission unit 128 to the normal processing mode in which the image information input from the camera 112 and the data received from the upstream camera adapter 120 are transmitted using the paths 401 and 402, respectively (step S1213). In this normal processing mode, steps S1214 and S1215 which are the same processes as those of steps S605 and S606 according to the first embodiment are executed. That is, the camera adapter 120b performs compression-coding processing on the camera image (inappropriate image) from the camera 112b (step S1214). Subsequently, the camera adapter 120b segments the compression-coded image (inappropriate image), the sound data, and the information of inadequacy into packets of a size defined by the transmission protocol, and outputs the segmented data packets via the data transmission unit 128 (step S1215).

As described above, according to the second embodiment, when an image captured by a camera is determined to be an inappropriate image over a predetermined period, the inappropriate image is transmitted to the server together with the information of inadequacy. Periods other than that are set to the bypass mode, and the camera adapter does not transmit, to the image computing server, the captured image determined to be an inappropriate image. Therefore, the transmission path can be used for transmitting other images during the bypass mode processing. For example, the compression rate of the foreground image and the background image can be lowered to improve image quality.

### Third Embodiment

The camera adapter 120 according to the first embodiment and the second embodiment transmitted the information of inadequacy with the inappropriate image. In the third embodiment, if a captured image (camera image) of a camera 112 is determined to be unsuitable for generating a virtual viewpoint image, information of inadequacy and a captured image corresponding to the information of inadequacy are transmitted in response to a request from the outside. For example, in a case in which it is determined that a camera image is an inappropriate image, first, a camera adapter 120 transmits information of inadequacy to an image computing server 200. Subsequently, when the display of the inappropriate image is instructed by an operator by operation of a virtual camera operation UI 330, a transmission request for the inappropriate image is output to a corresponding sensor system 110 that output the information of inadequacy. Upon receiving this request, the camera adapter 120 transmits the information of inadequacy and the camera image determined to be an inappropriate image. The virtual camera operation UI 330 displays, in place a virtual viewpoint content, the camera image (inappropriate image) transmitted from the camera adapter 120.

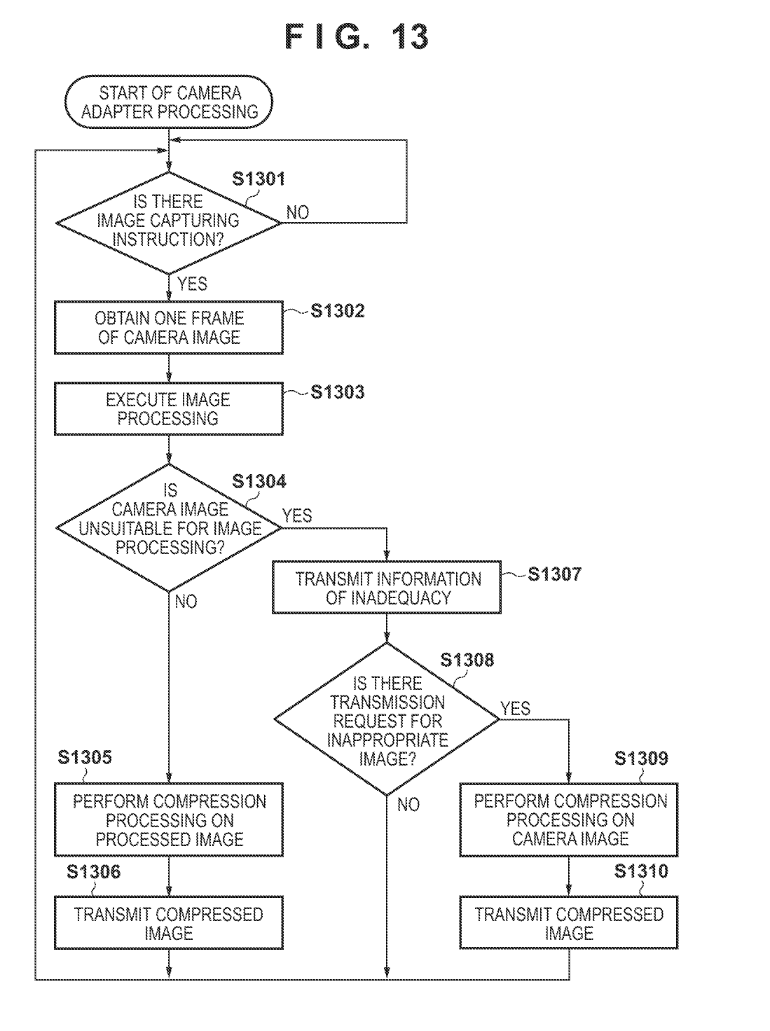

FIG. 13 is a flowchart showing processing by the camera adapter according to the third embodiment. The processes of steps S1301 to S1306 are the same as the processes of steps S601 to S606 according to the first embodiment (FIG. 6).

Upon receiving an image capturing instruction of obtaining an image from the camera 112 (step S1301), the camera adapter 120 obtains one frame of a camera image (step S1302). A separation unit 124 executes image processing of generating a foreground image and a background image and stores the generated images in a storage unit 126 (step S1303). Next, a determination unit 123 determines whether the camera image is an inappropriate image unsuitable for generating a virtual viewpoint content (step S1304). If it is determined that the camera image is not an inappropriate image, an encoding unit 127 performs compression-coding processing on the foreground image and the background image (step S1305). A data transmission unit 128 segments the data of the compression-coded foreground image and background image and the sound data into packets of a size defined by a transmission protocol and outputs the segmented data packets (step S1306).

On the other hand, if it is determined in step S1304 that the camera image is an inappropriate image, the data transmission unit 128 segments the information of inadequacy, output from the determination unit 123, into packets of a size defined by the transmission protocol and outputs the segmented information packets via the data transmission unit 128 (step S1307). As a result, in the virtual camera operation UI 330, a sensor system management display unit 902 shown in FIG. 9A displays sensor system management information to notify the operator of the transmission of the information of inadequacy from the sensor system. When the operator selects a display button 921 on the screen shown in FIG. 9A, a control station 310 outputs via a network 310a a transmission request for the inappropriate image to the sensor system 110 that generated the information of inadequacy.

When the camera adapter 120 that transmitted the information of inadequacy detects that the transmission request for the inappropriate image has been output from a control station 310 (YES in step S1308), the camera image (that is, the inappropriate image) is transmitted. More specifically, the encoding unit 127 performs compression processing on the camera image from the camera 112 (step S1309), and the data transmission unit 128 segments the compressed camera image and sound data into packets of a size defined by the transmission protocol and outputs the segmented data packets (step S1310).

Upon detecting that the inappropriate image has been transmitted from the camera adapter 120 that output the information of inadequacy, the control station 310 holds the image data. The virtual camera operation UI 330 displays, on the display screen, the received inappropriate image in place of the virtual camera image display output from a back end server 270.

As described above, according to the third embodiment, if a camera image is an inappropriate image unsuitable for generating a virtual viewpoint content, the camera adapter 120 first outputs the information of inadequacy. Subsequently, when the operator makes an instruction to display the inappropriate image, the control station 310 requests the sensor system that output the information of inadequacy to transmit the inappropriate image. Hence, since the transmission of the inappropriate image is limited to necessary times, the data transfer amount can be decreased. In addition, display of the inappropriate image is possible without having to add, to the server, processing according to the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-094877, filed May 11, 2017 which is hereby incorporated by reference herein in its entirety.

What is claimed is:

1. An image processing apparatus comprising:
an obtainment unit configured to obtain a captured image from one or more cameras;
a determination unit configured to determine whether the captured image obtained by the obtainment unit is not to be used for generating a virtual viewpoint image corresponding to a position and a direction of a virtual viewpoint; and
a notification unit configured to notify a generation device, which is configured to generate the virtual viewpoint image, of information indicating a determination result by the determination unit.

2. The apparatus according to claim 1, wherein the determination unit executes detection processing for detecting a specific object from the captured image, and the captured image in which the specific object has been detected is determined not to be used for generating the virtual viewpoint image.

3. The apparatus according to claim 2, wherein the specific object is at least an object that satisfies at least one of conditions of an object of a size not less than a threshold and an object which does not have a predetermined image pattern.

4. The apparatus according to claim 2, wherein the specific object is an object that moves at a speed not less than a threshold.

5. The apparatus according to claim 1, wherein the determination unit determines, based on a result comparing captured images from two or more cameras, whether the captured image from the one or more cameras is not to be used for generating the virtual viewpoint image.

6. The apparatus according to claim 5, wherein the determination unit determines whether the captured image from the one or more cameras is not to be used for generating the virtual viewpoint image based on at least one or a combination of
(1) a difference between a size of an object detected from a captured image of a first camera and a size of an object detected from a captured image of a second camera,
(2) a pixel count in which a difference between pixel values of the captured image of the first camera and pixel values of the captured image of the second camera is not less than a threshold, and
(3) a comparison of statistical information related to the pixel values of the captured image of the first camera and the pixel values of the captured image of the second camera.

7. The apparatus according to claim 1, wherein the virtual viewpoint image is generated based on three-dimensional shape model information that is generated by using captured images other than a captured image determined, by the determination unit, not to be used for generating the virtual viewpoint image.

8. The apparatus according to claim 1, wherein the virtual viewpoint image is generated based on composition processing of one or a plurality of captured images specified based on the position and direction of the virtual viewpoint among captured images other than a captured image determined, by the determination unit, not to be used for generating the virtual viewpoint image.

9. The apparatus according to claim 1, wherein the notification unit transmits, to the generation device of generating the virtual viewpoint image, added image data obtained by adding predetermined information of inadequacy to image data corresponding to a captured image determined, by the determination unit, not to be used for generating the virtual viewpoint image.

10. The apparatus according to claim 9, further comprising:
a compression unit configured to compress the image data corresponding to the captured image determined, by the determination unit, not to be used for generating the virtual viewpoint image at a compression rate higher than that for image data corresponding to a captured image that has not been determined not to be used for generating the virtual viewpoint image,
wherein the notification unit transmits the image data compressed by the compression unit to the generation device.

11. The apparatus according to claim 9, wherein the notification unit transmits image data corresponding to a captured image of a period determined, by the determination unit, not to be used for generating the virtual viewpoint image at a lower frame rate than image data corresponding to a captured image of a period that has not been determined not to be used for generating the virtual viewpoint image.

12. The apparatus according to claim 1, wherein the notification unit does not transmit, to the generation device for generating the virtual viewpoint image, image data corresponding to a captured image that has not been determined, by the determination unit, not to be used for generating the virtual viewpoint image data, and the notification unit transmits, to the generation device, a captured image determined not to be used for generating the virtual viewpoint image.

13. An image processing method for generating a virtual viewpoint image corresponding to a position and a direction of a virtual viewpoint, the method comprising:
obtaining information related to the position and the direction of the virtual viewpoint;
obtaining a captured image from one or more cameras;
determining whether the obtained captured image is to be used for generating the virtual viewpoint image; and
generating, based on the captured image corresponding to the determination result, a virtual viewpoint image corresponding to the position and the direction of the virtual viewpoint.

14. A non-transitory computer-readable storage medium storing a program configured to cause a computer to execute an image processing method for generating a virtual viewpoint image corresponding to a position and a direction of a virtual viewpoint, the method comprising:
obtaining information related to the position and the direction of the virtual viewpoint;
obtaining a captured image from one or more cameras;
determining whether the obtained captured image is to be used for generating the virtual viewpoint image; and
generating, based on the captured image corresponding to the determination result, a virtual viewpoint image corresponding to the position and the direction of the virtual viewpoint.
